(19) United States
(12) Patent Application Publication
(10) Pub. No.: US 2003/0047495 A1
(43) Pub. Date: Mar. 13, 2003

(54) Abrasive removal system

(76) Inventor: Stephen G. Olejnik, San Diego, CA (US)

Correspondence Address: Joseph W. Holland, P. O. Box 1840, Boise, ID, 83701-1840, US

(21) Appl. No.: 09/954,334

(22) Filed: Sep. 11, 2001

(51) Int. Cl. B04C 5/02

(52) U.S. Cl. 209/734

(57) ABSTRACT

An abrasive removal system for a wet abrasive cutting system includes a recovery tank for receiving a flow from a fluid abrasive cutting jet. A pump is fluidly connected to the recovery tank for removing an abrasive laden slurry from the recovery tank by suction. The pump creates a negative pressure which is directed, in the preferred embodiment of the invention, through a balanced suction manifold which is fluidly connected upstream from the centrifugal pump and positioned in the recovery tank providing a substantially even suction within a lower portion of the recovery tank. In the preferred embodiment of the abrasive removal system, the balanced suction manifold includes a plurality of balanced suction nozzles fluidly connected to and extending from the balanced suction manifold. A solids separator is fluidly connected downstream to the centrifugal pump and removes abrasive grit from the abrasive laden slurry.

### BACKGROUND OF THE INVENTION

1. Technical Field

This invention relates to wet abrasive cutting systems and more particularly to an abrasive removal system for a wet abrasive cutting system.

2. Background

The basic principle of abrasive water jet cutting involves directing a narrow, focused, water jet mixed with abrasive particles at a work piece. This jet is sprayed with very high pressures resulting in high velocities that cut through the work piece. The cutting mechanism is erosion.

The basic system for the abrasive water jet cutting process employs one or more pumps and/or compressors for increasing water pressure, piping for fluid connection of system components, an abrasive hopper for delivering an abrasive into the pressurized fluid stream, a mixing chamber for mixing the abrasive into the pressurized fluid stream and a cutting nozzle for directing the abrasive water jet at the work piece. The system for the abrasive water jet cutting process may also include intensifiers for increasing operating pressures, accumulators providing pressurized fluid storage capacity, one or more filters for purifying water, a numerically controlled gantry for positioning the cutting nozzle and a catcher for stopping the abrasive water jet beyond the work piece. The catcher functions to reduce the pressure of the abrasive jet and to reduce noise and dust in the work environment.

Typical jet pressures for abrasive water jet cutting are on the order of 10-100 Kpsi. Required jet pressure may decrease with the use of harder abrasives. Abrasive water jet cutting reduces cutting forces, and virtually eliminates heating in the cutting process. There is no contact between the cutting device and the work piece and therefore there is no tool wear. Abrasive water jet cutting is preferred for materials that cannot be subjected to high temperatures. The same basic device may be used as well for cutting steel plate over 3″ thick.

Removal and handling of spent abrasives has proven problematic. In the simplest systems an abrasive mud is removed periodically from the recovery tank necessitating shut down and lost time for the cutting device. This may be acceptable in a low volume application. There is however motivation to provide for a less intrusive method and device for evacuating abrasive materials used in the abrasive water jet cutting process from the recovery tank.

It is known in the prior art to recycle a wet slurry of an abrasive media. U.S. Pat. No. 5,049,260 to Spears discloses a hopper located in a blast area into which a waste stream falls. A separation system recycles a wet slurry of blast media. In addition to avoiding pollution and improving the workplace environment, it also is desirable to recover waste material for re-use. It is known in the prior art to recover an abrasive material from a captured waste stream. U.S. Pat. No. 4,984,397 to Van Leeuwen discloses an abrasive (dry) blasting system for separating grit and dust through progressive baffling which feeds the grit back into a supply tank for re-use.

It is known in the prior art to provide an abrasive removal system for a wet abrasive cutting system including a recovery tank for receiving a flow from a fluid abrasive cutting jet. A pump is fluidly connected to the recovery tank for providing suction for removing an abrasive laden slurry from the recovery tank. In the prior art, a solids separator is fluidly connected downstream from the pump and removes the abrasive grit from the abrasive laden slurry. The abrasive removal system of the prior art includes a recovery tank having an inclined bed. It is intended that the inclined bed feed the abrasive laden slurry by gravity towards a suction nozzle. In addition, spray nozzles directed at the bed of the recovery tank provide a stream of water for sweeping the abrasive laden slurry towards the suction nozzle.

The drawback with this system lies in the fact that the abrasive laden slurry must be transported in the first place, regardless of the mechanism, i.e. water jet or gravity. There would be advantage in providing an abrasive removal system that provides a substantially balanced suction in the recovery tank for removing the abrasive laden slurry from the recovery tank.

### SUMMARY OF THE INVENTION

The present invention is directed to an abrasive removal system for a wet abrasive cutting system. The abrasive removal system includes a recovery tank for receiving a flow from a fluid abrasive cutting jet. A pump is fluidly connected to the recovery tank for removing an abrasive laden slurry from the recovery tank by suction. The pump creates a negative pressure which is directed, in the preferred embodiment of the invention, through a balanced suction manifold. The balanced suction manifold is fluidly connected upstream from the centrifugal pump and is positioned in the recovery tank providing a substantially even suction within the recovery tank. A solids separator is fluidly connected downstream to the centrifugal pump and removes the abrasive grit from the abrasive laden slurry. In the preferred embodiment of the abrasive removal system, the balanced suction manifold includes a plurality of balanced suction nozzles fluidly connected to and extending from the balanced suction manifold. In the preferred embodiment of the abrasive removal system, the balanced suction manifold is located within the bottom portion of the recovery tank and preferably within the bottom quarter of a depth of the recovery tank. By bottom portion, it is meant within the bottom one half of a depth of the recovery tank. The balanced suction manifold is positioned on a substantially horizontal plane such that a plurality of balanced suction nozzles are spaced substantially equally throughout the bottom quarter of the depth of the recovery tank. Each balanced suction nozzle includes a nozzle end including a plurality of inlet ports with a substantially equal distance being observed between any two adjacent inlet ports. The preferred embodiment provides a balanced suction and therefore substantially even removal of the abrasive laden slurry from the recovery tank.

In the preferred embodiment of the abrasive removal system, the centrifugal pump is a Series 118/178/250 manufactured by MCM Centrifugal Pumps or equivalent capacity depending on the application. In the preferred embodiment of the abrasive removal system, the cyclonic separator includes cyclone sizes of 4 inches through 12 inches such as those manufactured by Sweco, Demco, Harrisburg or equal as determined by application.

In operation, an abrasive cutting jet process is performed above the recovery tank with the spent abrasive laden slurry being deposited in the recovery tank and sinking to the bottom portion of the recovery tank.

The centrifugal pump creates suction at the balanced suction manifold through the suction line and abrasive laden slurry is drawn at a substantially equal rate through the plurality of balanced suction nozzles from the bottom portion of the recovery tank. The abrasive laden slurry is drawn through a strainer basket and the centrifugal pump. The strainer basket removes large solids. The outlet of the centrifugal pump is connected to and fluidly communicates with a cyclonic separator. The abrasive laden slurry is processed through the cyclonic separator which deposits solids from the slurry into a solids collection caddy. The water is returned from the cyclonic separator to the recovery tank through an outflow line.

Operation of the system may be manual or by automatic operation via a control panel including an electronic processing device. The system components may be isolated employing upstream and downstream isolation valves as desired. The solids collection caddy may include wheels or may be removable via a separate device such as a forklift, crane or similar equipment.

These and other aspects and advantages of the invention will be better understood by reference to the following detailed description taken in conjunction with the accompanying drawings.

### BRIEF DESCRIPTION OF THE DRAWINGS

FIG. 1 is a representative schematic diagram of an abrasive removal system for a wet abrasive cutting system;

FIG. 2 is a representative top view of a balanced suction manifold for an abrasive removal system for a wet abrasive cutting system;

FIG. 3 is a representative top view of an assembled balanced suction nozzle for an abrasive removal system for a wet abrasive cutting system; and

FIG. 4 is a representative top view of a disassembled balanced suction nozzle for an abrasive removal system for a wet abrasive cutting system.

### DETAILED DESCRIPTION OF THE INVENTION

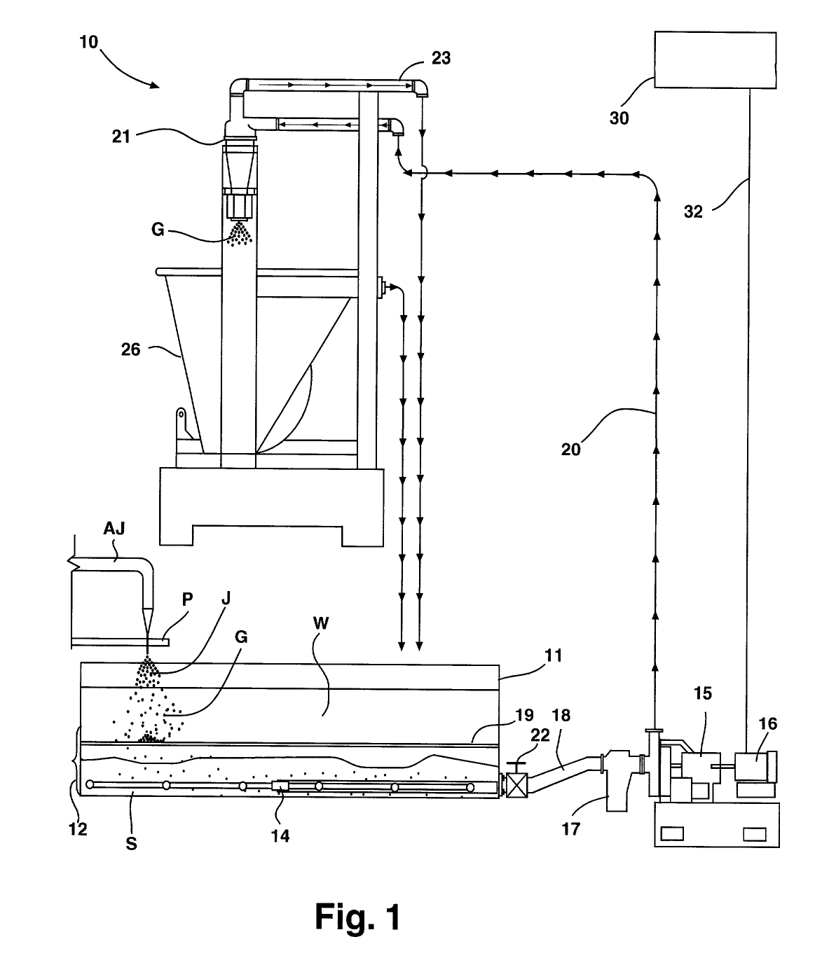

Referring to FIGS. 1 through 4, abrasive removal system 10 will be described in more complete detail. As shown in FIG. 1, abrasive removal system 10 includes generally recovery tank 11 which is positioned in use below abrasive cutting jet AJ. As a cutting operation proceeds, water jet J containing abrasive grit G cuts through work piece P and the water jet J with abrasive grit G are directed towards recovery tank 11. Recovery tank 11 contains both water and an abrasive grit laden slurry S. Balanced suction manifold 14 is located generally in lower portion 12 of recovery tank 11. Screen 19 is positioned within recovery tank 11 above balanced suction manifold 14 to prevent solids above a predetermined diameter from entering abrasive grit laden slurry S. In the embodiment shown, screen 19 is configured to retain solids having a diameter greater than 0.125 inches.

Centrifugal pump 15 is connected to and fluidly communicates with balanced suction manifold 14 through suction line 18 and driven by pump motor 16. Strainer 17 is shown connected between balanced suction manifold 14 and centrifugal pump 15 and, in the preferred embodiment, serves to remove solids having a size exceeding 0.150 inches diameter. Alternately, strainer 17 may be configured to remove solids in the range substantially equal to ⅛ inches diameter to ¼ inches diameter. Centrifugal pump 15 pumps abrasive grit laden slurry S through separator in-feed line 20 to cyclonic solids separator 21. Cyclonic solids separator 21 is powered by the flow and pressure of slurry S. Following processing by cyclonic solids separator 21, solids G are deposited to solids collection caddy 26 and treated water W is returned to recovery tank 11 through outflow line 23. Centrifugal pump 15 may be isolated for maintenance or other purposes by pump isolation valve 22.

FIG. 1 also shows to advantage control panel. Control panel 30 is connected to pump motor 16 by conductor 32.

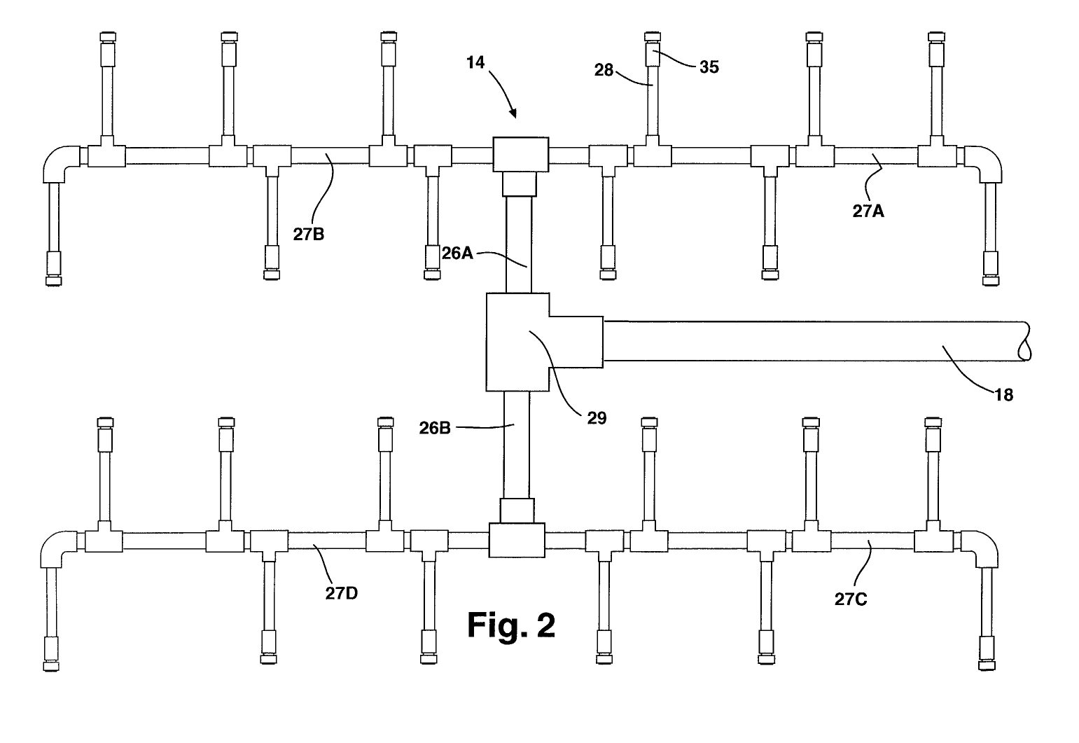

Referring to FIG. 2, balanced suction manifold 14 is shown more completely in a representative top view. As shown, balanced suction manifold 14 includes T fitting 29 which is connected to and fluidly communicates with suction line 18, first manifold header 26A and second manifold header 26B. First manifold header 26A is connected to and fluidly communicates with first manifold sub-header 27A and second manifold sub-header 27B. Similarly, second manifold header 26B is connected to and fluidly communicates with third manifold sub-header 27C and fourth manifold sub-header 27D. Manifold branch 28 is typical of the plurality of branches that extend laterally from first manifold sub-header 27A, second manifold sub-header 27B, third manifold sub-header 27C and fourth manifold sub-header 27D. Balanced suction nozzle 35 is connected to and fluidly communicates with manifold branch 28, this connection also being typical of the plurality of suction nozzles that are connected to the plurality of branches.

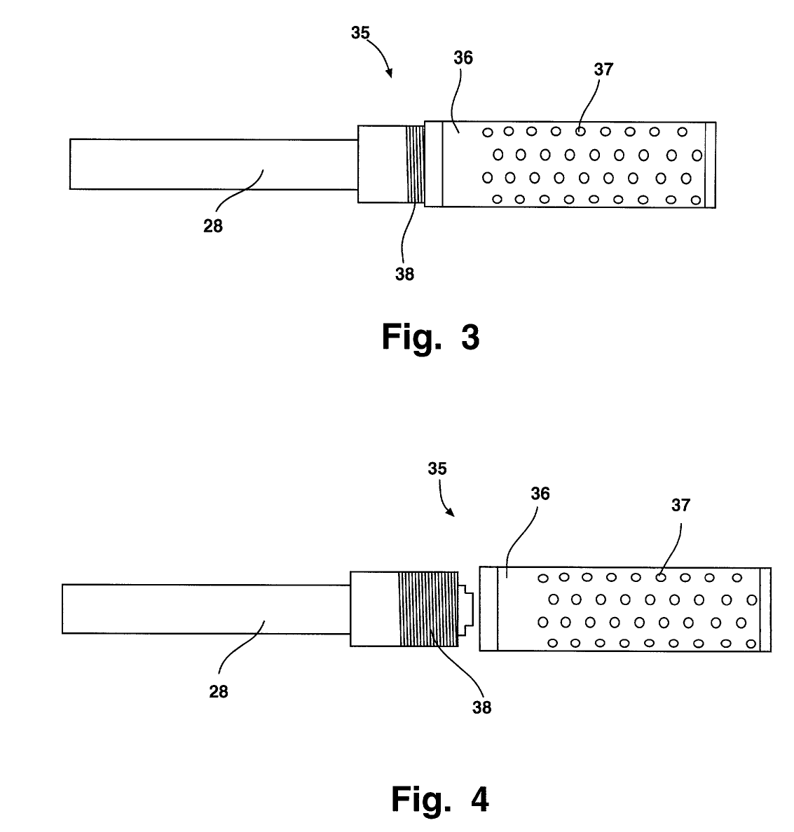

FIGS. 3 and 4 show balanced suction nozzle 35 including nozzle body 36 including a plurality of apertures 37 located at intermittent intervals across the surface of nozzle body 36. Nozzle body 36 is threadedly connected to manifold branch 28 at thread 38.

Referring to FIGS. 1 through 4, abrasive grit laden slurry S is drawn from recovery tank 11 through apertures 37 of each of the plurality of nozzle bodies 36 by centrifugal pump 15. Abrasive grit laden slurry S is processed by cyclonic solids separator 21 and solids G are deposited to solids collection caddy 26 and treated water W is returned to recovery tank 11 through outflow line 23.

While this invention has been described with reference to the detailed embodiments, this is not meant to be construed in a limiting sense. Various modifications to the described embodiments, as well as additional embodiments of the invention, will be apparent to persons skilled in the art upon reference to this description. It is therefore contemplated that the appended claims will cover any such modifications or embodiments as fall within the true scope of the invention.

I claim:

1. An abrasive removal system comprising:
a recovery tank for receiving a fluid jet including an abrasive grit and containing a fluid and a slurry;
a balanced suction manifold positioned within the recovery tank;
a pump connected to and in fluid communication with the balanced suction manifold for providing a substantially even suction within the recovery tank for removing the slurry; and
a solids separator fluidly connected to and in fluid communication with the pump for removing the abrasive grit from the slurry.

2. The abrasive removal system of claim 1 wherein the balanced suction manifold further comprises one or more balanced suction nozzles.

3. The abrasive removal system of claim 1 wherein the balanced suction manifold further comprises the balanced suction manifold positioned in a lower portion of the recovery tank.

4. The abrasive removal system of claim 1 wherein the pump further comprises a centrifugal pump fluidly connected to the recovery tank for suctionally removing a slurry from the recovery tank.

5. The abrasive removal system of claim 1 wherein the solids separator further comprises a cyclonic solids separator fluidly connected downstream from the centrifugal pump for removing an abrasive grit from the slurry.

6. The abrasive removal system of claim 1 further comprising a solids collection caddy.

7. The abrasive removal system of claim 1 further comprising a portable solids collection caddy.
